(19) United States
(12) Patent Application Publication
(10) Pub. No.: US 2002/0019821 A1
(43) Pub. Date: Feb. 14, 2002

(54) Apparatus, systems and methods for presenting comparative information

(76) Inventor: Lee Rosenbluth, Bryn Mawr, PA (US)

Correspondence Address: DILWORTH PAXSON LLP, 3200 Mellon Bank Center, 1735 Market Street, Philadelphia, PA, 19103-7595, US

(21) Appl. No.: 09/737,374

(22) Filed: Mar. 12, 2001

Related U.S. Application Data
(60) Provisional application No. 60/172,504, filed on Dec. 17, 1999.

(51) Int. Cl. G06F 7/00

(52) U.S. Cl. 707/10

(57) ABSTRACT

Apparatus, systems and methods for presenting comparative information in a networked environment in the travel industry are disclosed. The apparatus, systems and methods aggregate data feeds from many disparate sources, thus providing reviewing, comparing and/or searching mechanisms for the information carried by those data feeds, as well as apparatus, systems and methods for purchasing, reserving and/or booking travel.

This application is related to provisional application U.S. Ser. No. 60/172,504, which disclosure is incorporated herein by reference.

### FIELD OF THE INVENTION

This invention relates to apparatus, systems and methods for presenting comparative information. More particularly, this invention relates to apparatus, systems and methods for presenting comparative information in a networked environment in the travel industry.

### BACKGROUND OF THE INVENTION

Travel information and data is provided in many media by many vendors. The range of media used by the vendors includes newspaper, television, magazines, mail, email, electronic data interchange (“EDI”), XML transmissions and the Internet. Reviewing all these media is very difficult if not impossible. For example a travel agent may need to review mail, email, EDI, and XML merely in order to understand all the travel vendors' offerings. Moreover, those offerings are constantly being changed, priced and re-priced as market conditions change so a travel agent has an even more difficult job when attempting to compare the information.

The travel industry and the technology industry has constantly grappled with the difficulty of providing information to travel professionals and consumers. For example, the attempt to provide a reservation system for airlines led to one of the first on line, time sharing computer systems (the “Semiautomatic Business Research Environment” or Sabre.) Neither the travel industry nor the technology industry, however, has been consistently able to provide information to the travel professional or the consumer and a comparative format. That is, there has been little or no ability to efficiently combine the many offerings from the many travel vendors in an easy to understand format that permits comparison among the offerings.

There also has been little or no ability to efficiently search the many offerings from the many travel vendors in a simple manner. Since the offerings come in many media, searching all these media simultaneously for a desired travel offering such as “All cruise line sailing in the Caribbean the second week of March, 2001” has simply been impossible.

Because the travel industry lacks any efficient comparison tool, and any efficient searching tool, it also lacks the ability to purchase, reserve or book offerings from travel vendors after a travel professional or consumer has reviewed the compared offerings or the results of his or her search. The usual booking process takes anywhere from twelve to fourteen steps. Eliminating at least some of these steps and providing such an instantaneous or nearly instantaneous purchasing, reservation and booking tool would greatly increase the efficiency of the travel industry.

Accordingly, it is an object of this invention to provide apparatus, systems and methods for reviewing, comparing and/or searching travel information.

It is a further object to provide apparatus, systems and methods for purchasing, reserving and/or booking travel.

### SUMMARY OF THE INVENTION

The present information provides apparatus, systems and methods for reviewing, comparing and/or searching travel information as well as apparatus, systems and methods for purchasing, reserving and/or booking travel. The preferred embodiments of the present invention receive manual and electronic transmissions of travel information including EDI, XML, SQL queries, screen scraping and others and present that information in an aggregated format such as through a Web site. The preferred embodiments also make possible comparison among the offerings, searching the offerings, and the purchase, reservation and/or booking of the various travel offerings contained in the information.

The preferred embodiments provide cruise industry information. Of course, other embodiments may provide information in the cruise industry and/or other travel industries.

### BRIEF DESCRIPTION OF THE DRAWINGS

FIG. 1 is a schematic diagram of a preferred embodiment.

FIG. 2 is a screen shot of a preferred embodiment.

FIG. 3 is another schematic diagram of the embodiment of FIG. 1.

FIG. 4 is a view taken from FIG. 3.

FIG. 5 is a screen shot of a preferred embodiment.

FIG. 6 is a screen shot of a preferred embodiment.

FIG. 7 is a screen shot of a preferred embodiment.

FIG. 8 is a screen shot of a preferred embodiment.

FIG. 9 is a screen shot of a preferred embodiment.

FIG. 10 is a screen shot of a preferred embodiment.

FIG. 11 is a screen shot of a preferred embodiment.

FIG. 12 is a screen shot of a preferred embodiment.

FIG. 13 is a screen shot of a preferred embodiment.

FIG. 14 is a screen shot of a preferred embodiment.

FIG. 15 is a screen shot of a preferred embodiment.

FIG. 16 is a screen shot of a preferred embodiment.

FIG. 17 is a screen shot of a preferred embodiment.

FIG. 18 is a screen shot of a preferred embodiment.

FIG. 19 is a screen shot of a preferred embodiment.

FIG. 20 is a schematic diagram of a preferred embodiment.

FIG. 21 is a schematic diagram of a preferred embodiment.

FIG. 22 is a schematic diagram of a preferred embodiment.

FIG. 23 is a schematic diagram of a preferred embodiment.

### DETAILED DESCRIPTION OF THE PREFERRED EMBODIMENTS

The preferred embodiments contain various tools to review, compare, and/or search travel information, as well as tools to purchase, reserve and/or book travel. The preferred embodiments of the present invention allow for the aggregation of various sources of information and their presentation to the user after aggregation. The latter attribute is initially described below. That description is then followed by a description of the various technical aspects of the aggregation of the sources of information.

The preferred embodiments are used in the cruise industry. Other embodiments may be used in other travel industries through modifications known in the art.

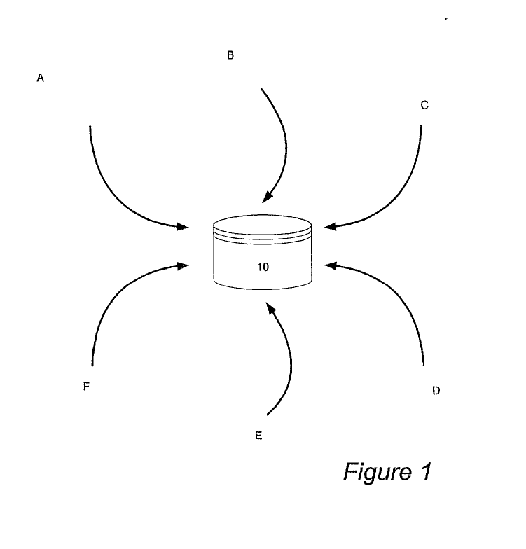

FIG. 1 shows a schematic diagram of data sources for a preferred embodiment. The data sources feed into central, on-line database 10, however the data sources do not provide data in consistent formats for entry into the database. Therefore, the preferred embodiments homogenize the data formats coming from the different data sources in order that the database may be populated with data in an orderly manner. This consistent homogenization and caching, by way of the database, of the various data sources provides efficient and timely access to the data coming from the various sources.

Data source A comprises, in this embodiment, data from Cruise Associates, which, includes itinerary and pricing for non-online bookable cruise lines. Data Source B comprises, in this embodiment, data from Cruise Mates which includes independent reviews of cruise lines and ships. Data Source C comprises, in this embodiment, data from Online News Bureaus, including cruise industry related news stories and press releases. Data Source D comprises, in this embodiment, data from various cruise lines, including cruise line, ship, and cabin descriptions, deck layouts, diagrams, cruise ship and cabin pictures. The preferred embodiment has a number of feeds from a number of cruise lines. Data Source E comprises, in this embodiment, miscellaneous data from various content providers. Data Source F comprises, in this embodiment, a data feed from the Sabre Global Distribution System (also known as a General Data Stream or GDS), comprising itinerary and pricing for online bookable cruise lines. These data feeds are described in greater detail below.

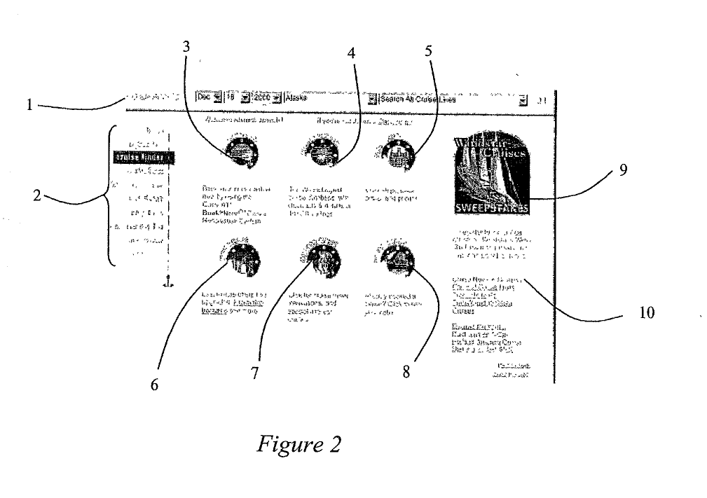

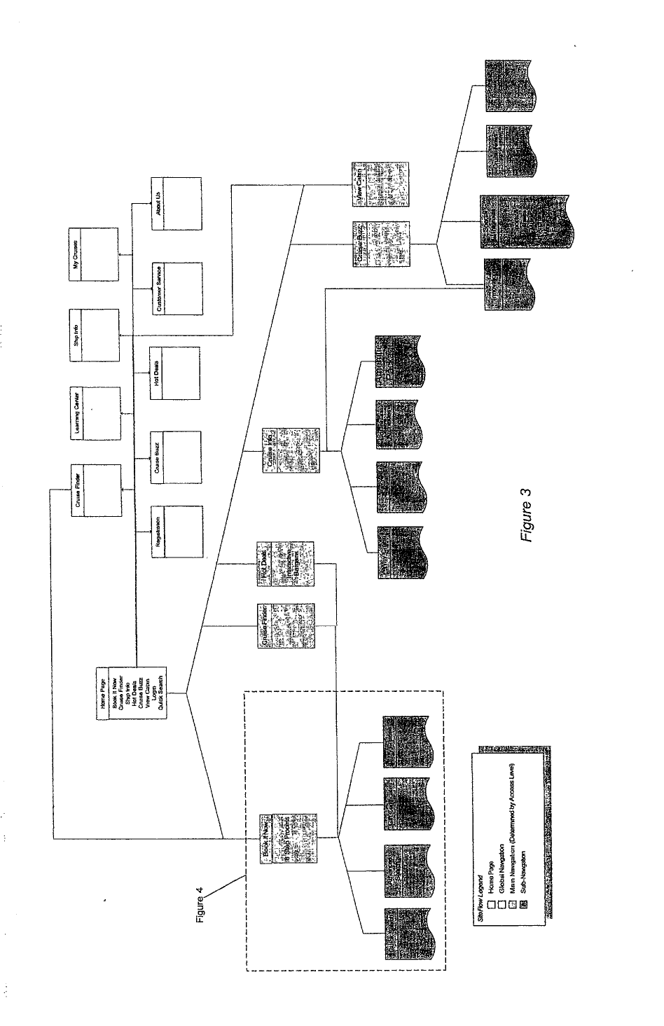

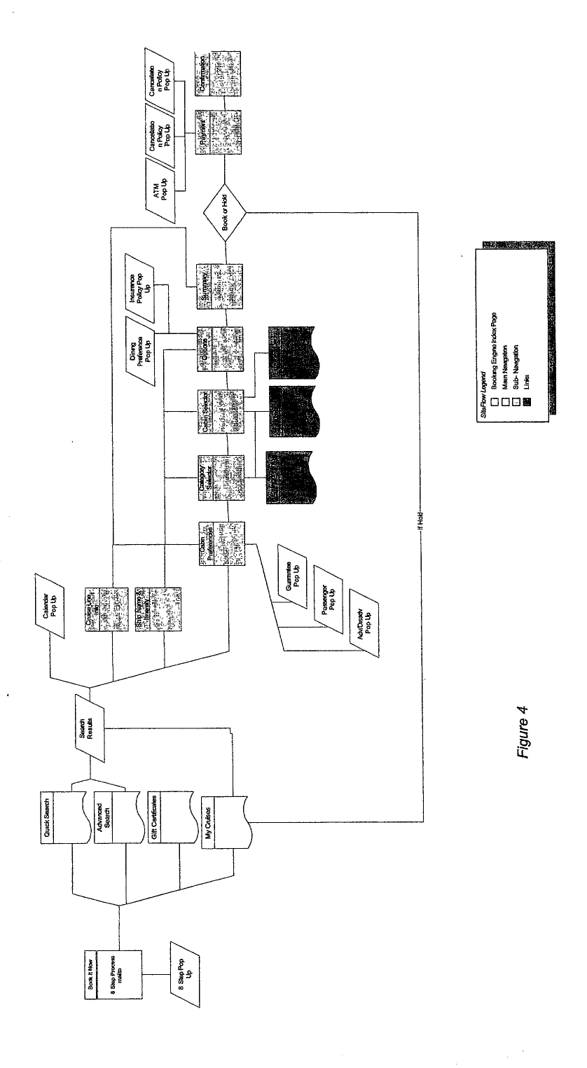

FIG. 2 shows a screen shot of an apparatus of a preferred embodiment. This apparatus comprises a Website connected to the Cruise Line Communication Processor and database described above. Search Tools 1 and 4 are provided in the apparatus. Navigation Panel Tool 2, Booking Tool 3, Information Tools 5 and 8, News Tools 6, 7 and 10, Advertisement and Promotional Area Tool 9 and Registration Tool 11 are also provided. FIG. 3 is a schematic diagram of the navigational flow through the apparatus of FIG. 1, and FIG. 4 is an exploded view taken from FIG. 3.

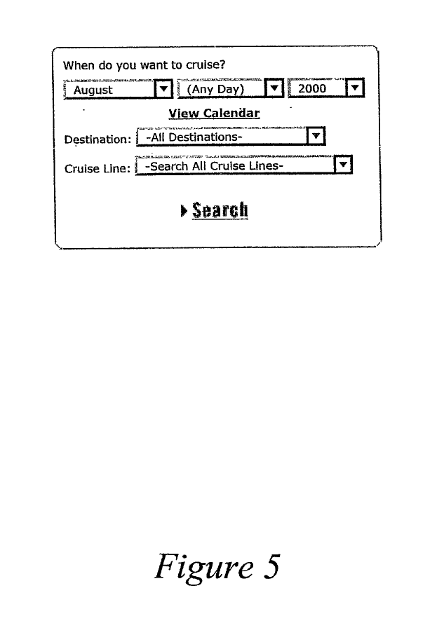

Returning now to FIG. 2, Reservation System Tool 3 initially moves the user to an information screen which provides information on the reservation process. The user then has the option to review more information on the process of this embodiment for obtaining cruise reservations. If the user chooses not to review the steps of the process, after selecting the Reservation System Tool 3, he or she is directed to the screen for the Search Tool 4. At FIG. 5, the screen for the Search Tool 4 in this embodiment the user is prompted to enter the desired parameters, including dates, destination, and cruise line. If cruises exist for the desired parameters, a results screen is then returned which can be further explored.

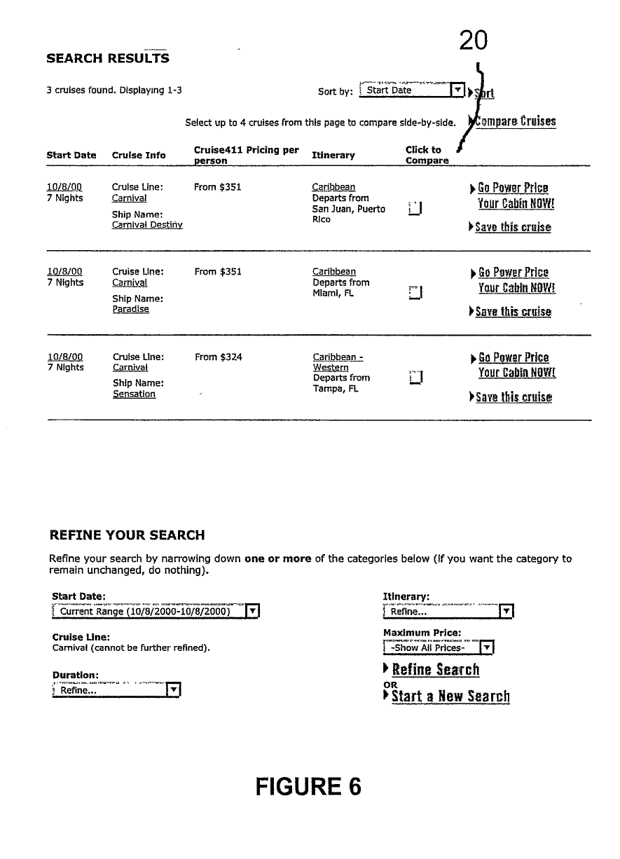

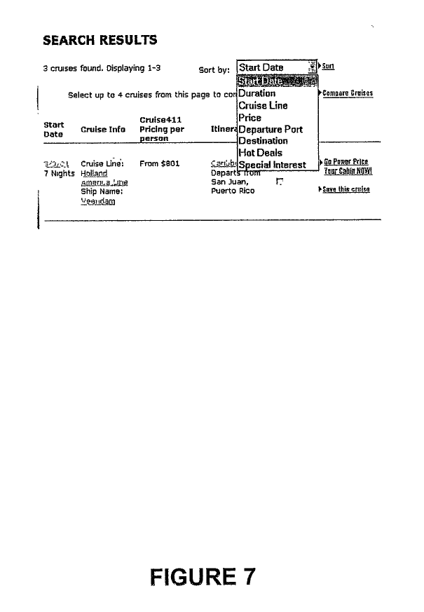

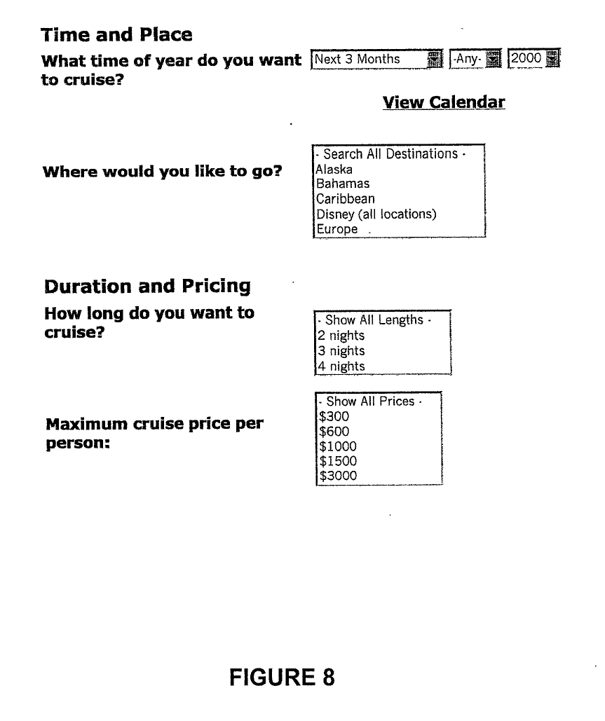

Turning to FIG. 6, a sample results screen is seen. This results screen can be sorted by various parameters in this embodiment, as is seen at FIG. 7. (Other embodiments may present different sort parameters.) There is a Second Search Tool in this embodiment. This second tool, an Advanced Search Option Tool, searches with different search parameters is seen at FIG. 8.

At 20 of FIG. 6 the option to compare up to four cruises in this embodiment is offered. This option comprises the Cruise Comparison Tool of this embodiment and provides the ability to compare various cruises from the results screen as a product of the search. Other embodiments may compare different numbers of cruises, provide different parameters for comparison, including the ability to select comparison parameters “on-the-fly,” and so on. The Cruise Comparison Tool of this embodiment also includes comparison pricing information. Not all choices may provide the information, depending on available data feeds. Other embodiments may provide different data and information to compare.

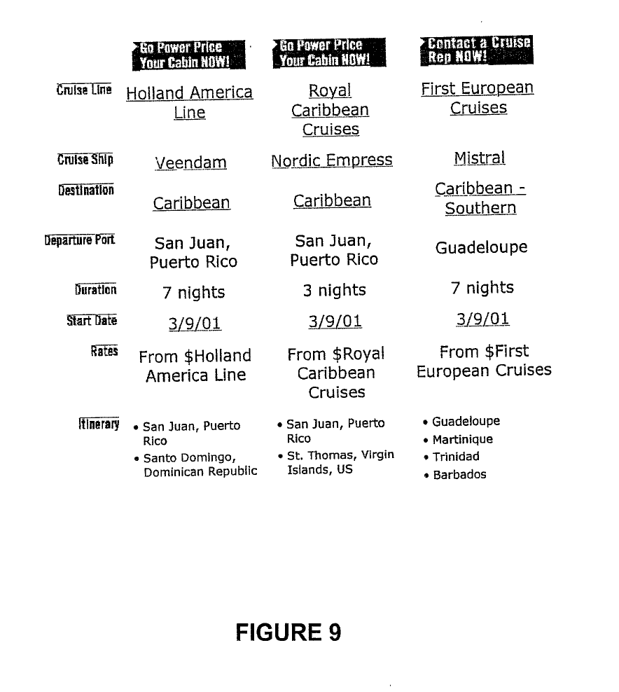

Turning to FIG. 9, a sample Cruise Comparison Screen, generated by the Cruise Comparison Tool is seen. Various predetermined parameters for the various predetermined cruises chosen in the search screen are shown in columnar format. Moreover, a number of hyperlinks to other information are shown, such as cruise line information, ship information, and cabin information.

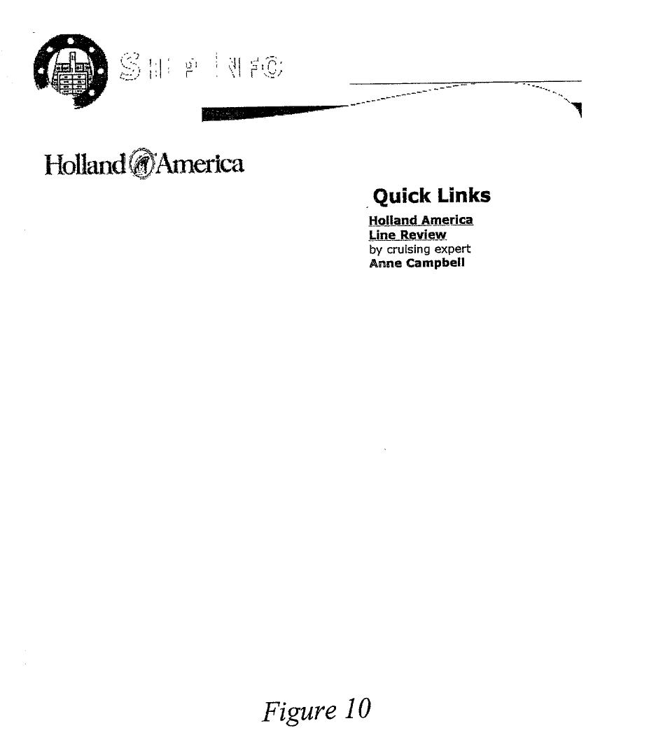

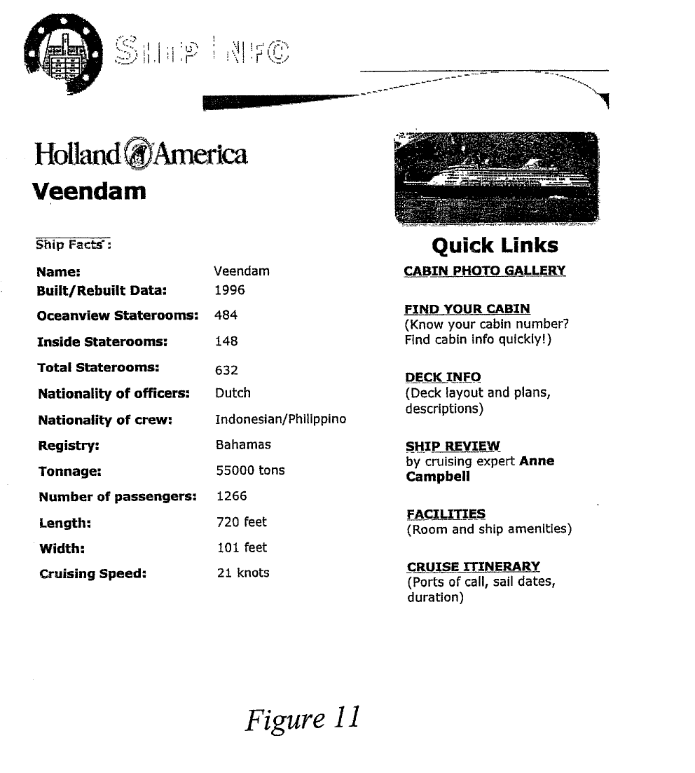

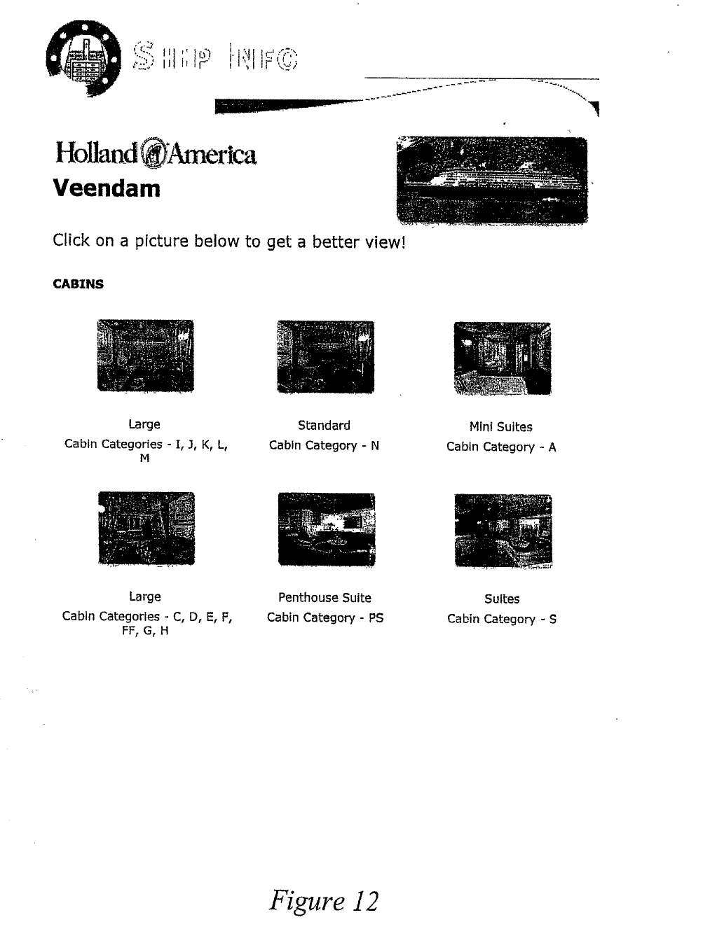

Examples of the hyperlinks from the cruise comparison screen to cruise line information, ship information and cabin information are shown at FIGS. 10, 11 and 12 respectively. The option to view line and ship information is also seen at the home page (FIG. 2).

The user may choose to proceed with pricing the cabin after using the Cruise Comparison Tool.

It should be noted that, in this embodiment, use of the Cruise Comparison Tool to obtain a booking or reservation is not essential. In other words, the user could instead use the eight step booking process of this embodiment:

1. Searching for a Cruise by date, itinerary, and/or cruise line, using a database of this embodiment (see e.g. FIG. 5);

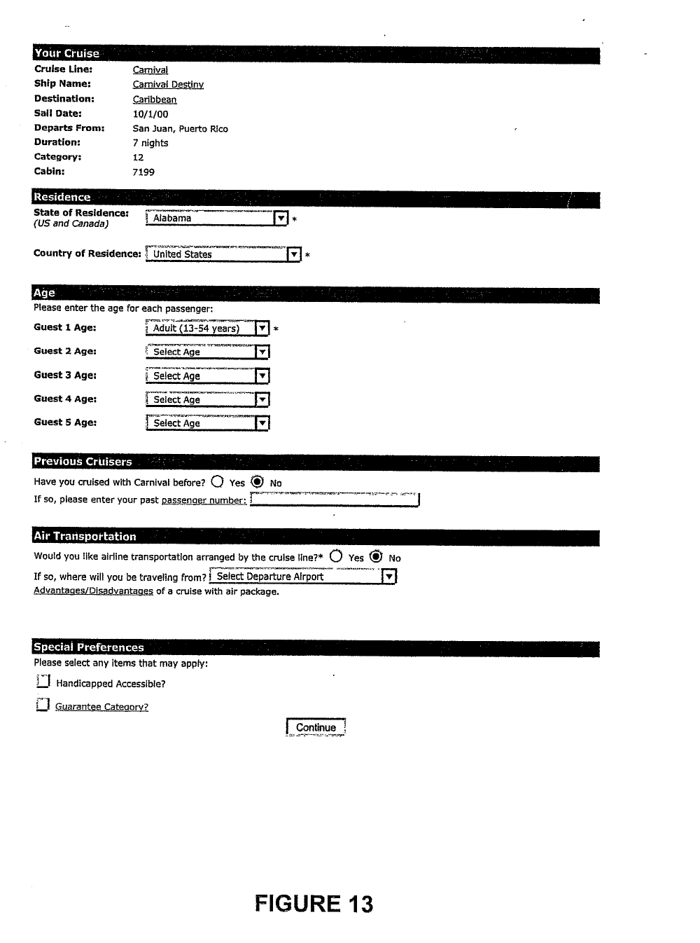

2. Selecting specific preferences to help choose and price a Cruise for the user (see e.g. FIG. 13);

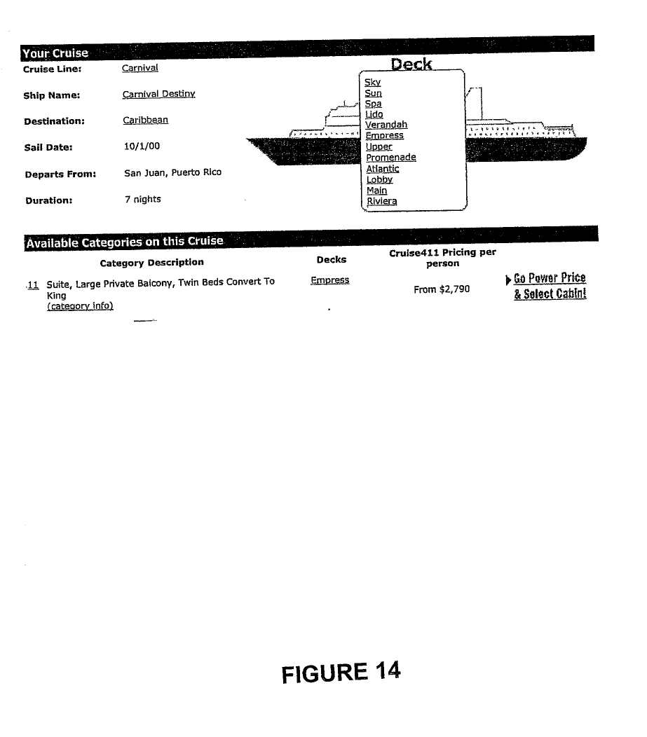

3. Selecting a specific Travel Class or Cabin Category (see e.g. FIG. 14);

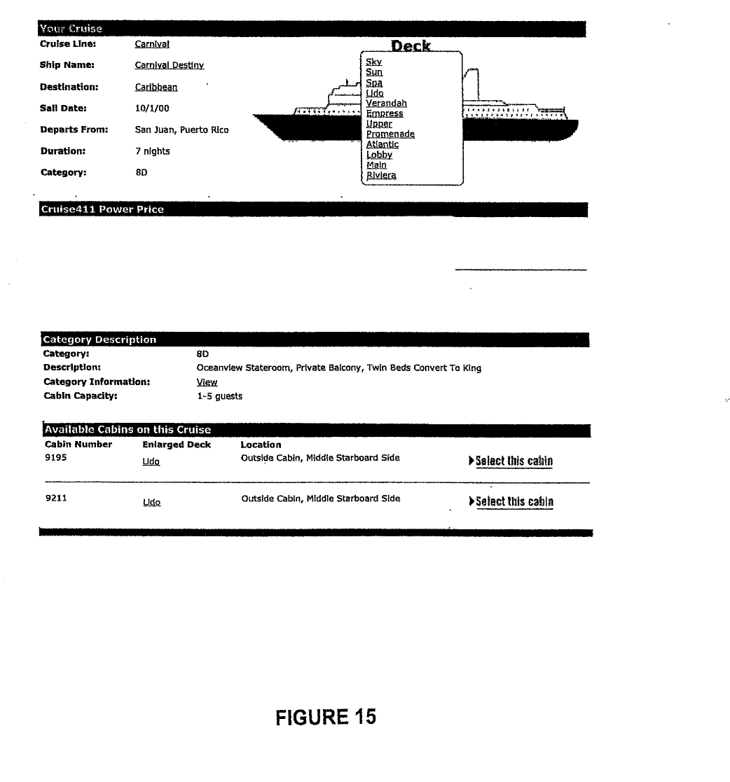

4. Selecting a specific Cabin location, and the preferred embodiments provide deck plans to assist in this step (see e.g. FIG. 15);

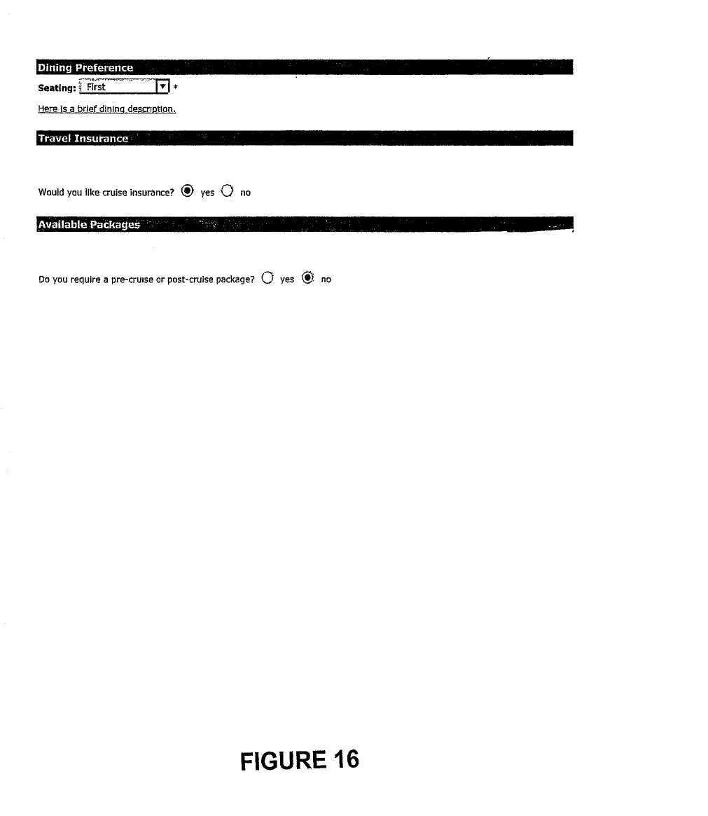

5. Selecting any other desired Add-On Options, such as travel insurance, pre- and post-cruise packages, etc. (see e.g. FIG. 16);

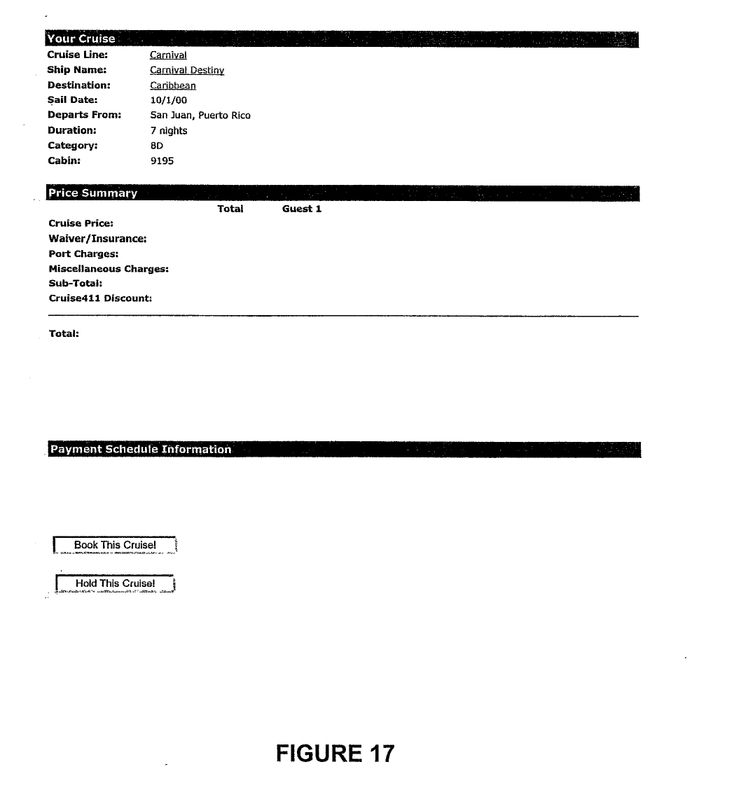

6. Providing a summary of all selections, including ship, sailing date, departure port, duration, itinerary, category, cabin, and the price. At this step, the user may, if desired, review and change all of the selected options (see e.g. FIG. 17);

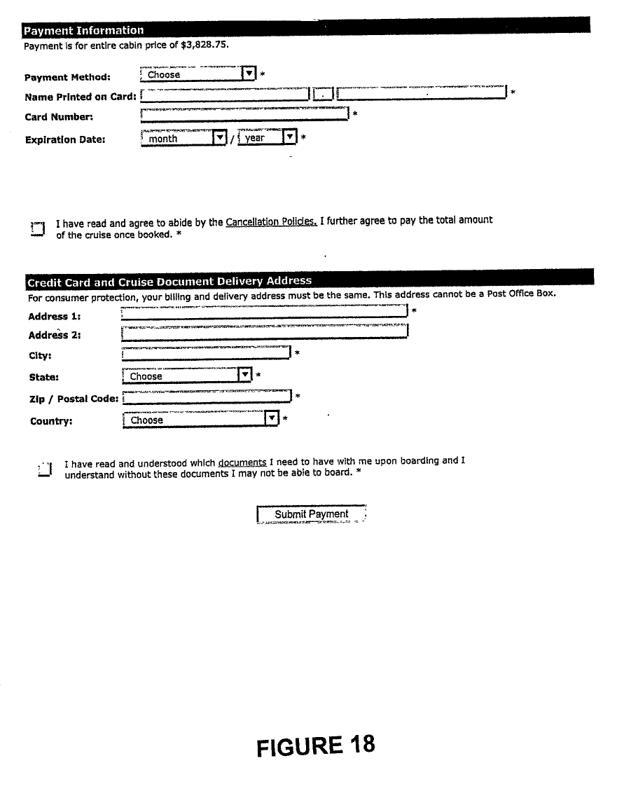

7. Paying for the cruise and agreeing to the terms and conditions (see e.g. FIG. 18);

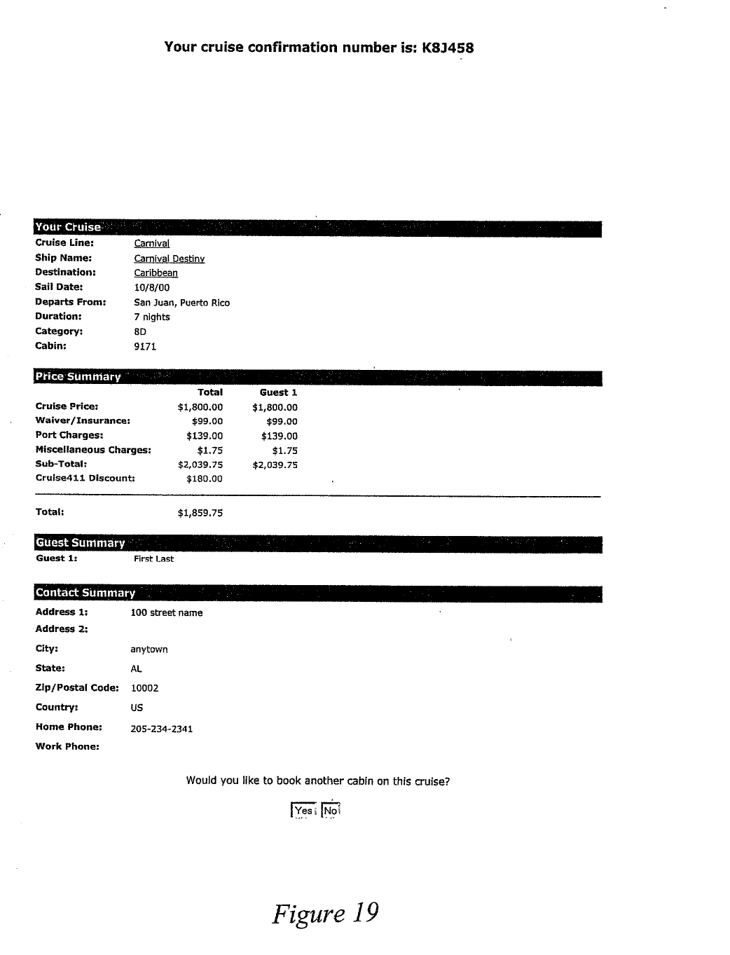

8. Confirming the cruise and providing a final summary (see e.g. FIG. 19).

Other embodiments may have a different process for obtaining cruise reservations. For example, steps 6 through 8 may be combined in some preferred embodiments. Additionally, as mentioned above, the user may use the Cruise Comparison Tool, preferably between steps 2 and 3, and pricing and repricing may occur at any of a number of steps.

Other components of the apparatus of FIG. 2 of the preferred embodiments include the Cruise Buzz Tool 7, the Advertisements and Promotional Tool 9, the News Tool 10, the Registration Tool 11 as well as various tools contained within the Navigation Panel Tool 2. These tools offer various other alternatives to the user. For example, the Cruise Buzz Tool 7 offers links to special interest cruises, innovations in cruising, cruise news and message boards, and the Learning Center Tool, contained within the Navigation Panel Tool 2, contains links to Articles and general information on cruising; the Ship Information Tool 5; Frequently Asked Questions about cruises; the Amenities offered on various lines, and the Accolades bestowed on various lines.

As noted above, the various tools described herein that review, compare, and/or search travel information, as well as tools to purchase, reserve and/or book travel require information or data feeds. A number of data or information feeds are used to provide travel information to the preferred embodiments. The Sabre Global Distribution System (also known as a General Data Stream or GDS) is used as a primary data feed. However, Sabre only provides data for a few of the cruise lines. (Presently Sabre provides data for only eight of over thirty cruise lines.) Therefore, the preferred embodiments have the flexibility to input data feeds from numerous other sources such as screen scraping, XML, etc. as further described below.

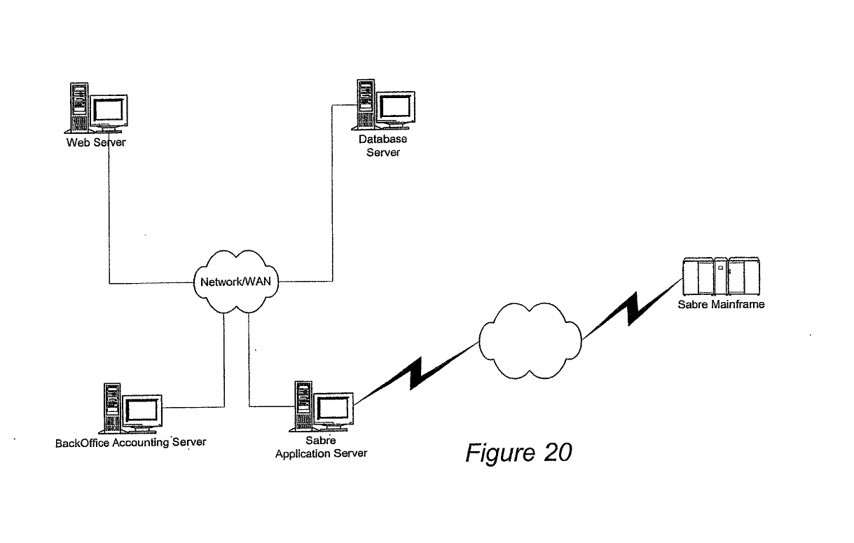

The interaction of the Sabre GDS with the local system is shown in FIG. 20. A frame relay connection is established with the Sabre mainframes by way of a local Sabre application server. A local back office accounting server provides transactional support, in a manner explained in further detail below. The local Sabre application server and local back office accounting server are linked to the database server and the Web server through a network or WAN.

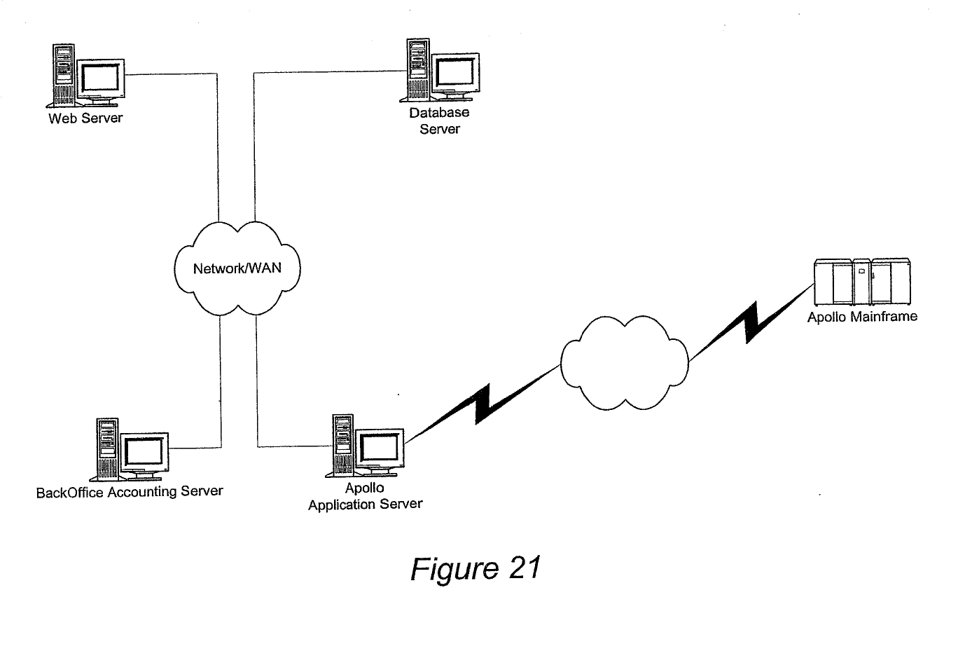

In other embodiments, additional or other data feeds from other GDS's such as Apollo, Worldspan and/or Amadeus may be used. For example the interaction of the Apollo GDS with the local system is shown in FIG. 21. This Apollo booking engine operates in much the same fashion as the Sabre booking engine. The Apollo mainframes and a local Apollo application server are substituted for the respective components of the Sabre booking engine. Otherwise, the architecture is similar to the Sabre network architecture.

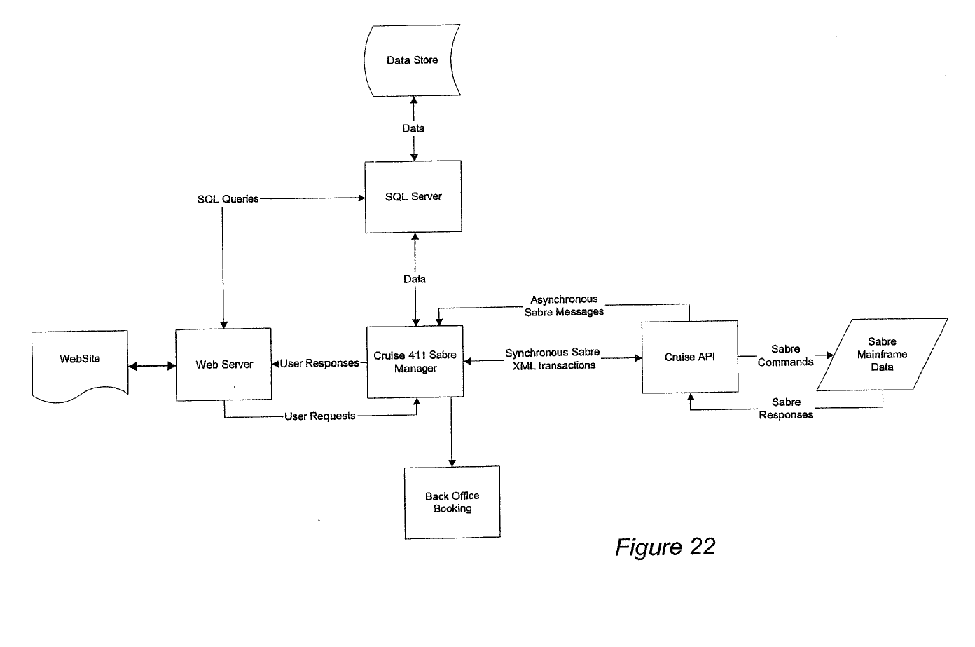

Returning now to the preferred embodiment utilizing the Sabre GDS, FIG. 22 shows the data flow from the Sabre GDS. The mainframe data passes to and from the local application server, in this embodiment an application server with a Sabre® Cruise Application Program Interface. Both asynchronous messages and synchronous transactions pass via the Sabre® Cruise Application Program Interface to a local Sabre Manager which populates the data store through an SQL Server. The local Sabre manager also provides any information responsive to the Web server and provides the connection to the back office booking mechanism. In this embodiment, the back office bookkeeping mechanism, which includes such matters as travel agency commissions and the like, occurs through an application known as GlobalWare.

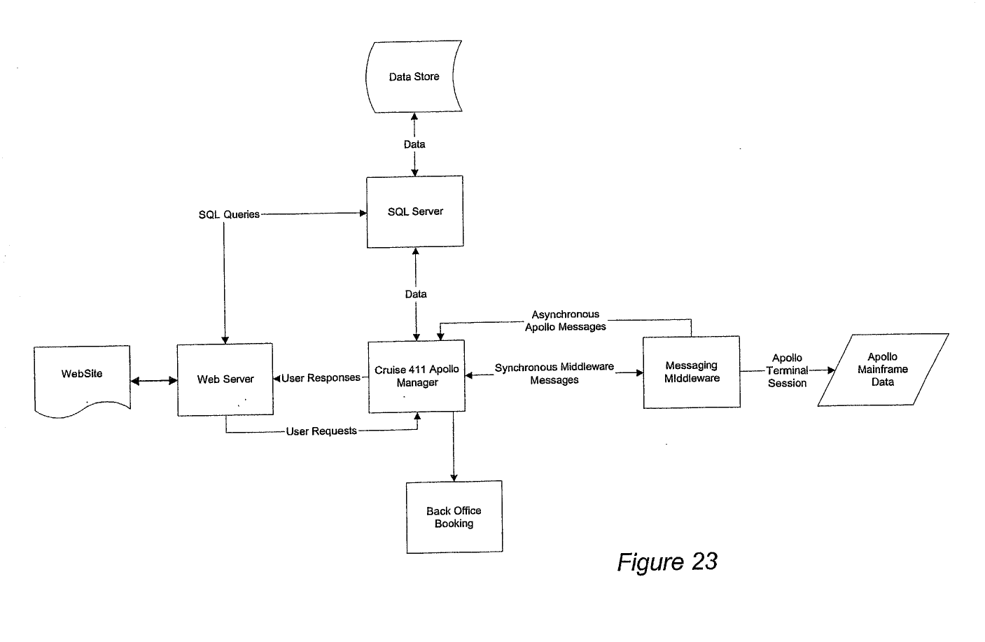

In other embodiments, additional or other data feeds from other GDS's, such as Apollo, Worldspan and/or Amadeus, may be used. For example, FIG. 23 shows the data flow from the Apollo GDS. The Apollo mainframe data is transmitted to and from the local messaging middleware application through a terminal session. Asynchronous and synchronous messages are transmitted to and from the messaging middleware to the local Apollo manager. Other direct or unique inventories may also be used, as well as direct data feeds from cruise lines.

For example, a primary source of cruise information in this embodiment is provided through Cruise Associates. The Cruise Associates data, transmitted through a weekly download, comprises a comma delimited file of information about cruise lines and ships. This data is copied into the central database of this embodiment, as shown in FIG. 1.

The preferred embodiments also may link with data feeds such as XML-based APIs. XML interfaces enable live feeds of information including inventory information to the Web server of the preferred embodiments. XML feeds are usually from the source and so provide quick response times. The preferred embodiments also may link with legacy systems through screen scraping. Screen scraping slows down information transfer because, inter alia, it requires several round trips between the transmitter and receiver, yet, screen scraping is still fairly widespread in the travel industry.

Yet another data feed is by way of purchased inventory. This information is relatively static and is entered into the local database and offered through the distressed inventory area.

It should be noted that various embodiments may have different storage structures, such as having more than one database, for example. Other methods of data transfer known in the art, for example using Java, may also be used in various embodiments.

The above description and the views and material depicted by the figures are for purposes of illustration only and are not intended to be, and should not be construed as, limitations on the invention.

Moreover, certain modifications or alternatives may suggest themselves to those skilled in the art upon reading of this specification, all of which are intended to be within the spirit and scope of the present invention as defined in the attached claims.

I claim:

1. An apparatus for comparing travel industry information comprising:
input means for at least two data feeds;
aggregation means for said data feeds;
search means for said aggregation means; and
presentation means for any output of said search means.

2. An apparatus as in claim 1 wherein said input means comprises at least one XML data feed.

3. An apparatus as in claim 1 wherein said input means comprises at least one data feed through an API.

4. An apparatus as in claim 1 wherein said aggregation means comprises a database means.

5. An apparatus as in claim 4 wherein said aggregation means further comprises a data homogenization means.

6. An apparatus as in claim 1 wherein said search means comprises;
a search interface means; and
a SQL query means.

7. An apparatus as in claim 6 wherein said apparatus further comprises an Internet access means.

8. An apparatus as in claim 7 wherein said presentation means further comprises a means for output over an Internet connection.

9. An apparatus for comparing cruise industry information comprising:
input means comprising at least one XML data feed and at least one data feed through an API;
aggregation means comprising a database for said data feeds;
search means for said aggregation means comprising a search interface means and a SQL query means; and
presentation means for any output of said search means.

10. An apparatus as in claim 9 wherein said apparatus further comprises an Internet access means.

11. An apparatus as in claim 9 wherein said presentation means further comprises a means for output over an Internet connection.

12. An apparatus as in claim 9 wherein said presentation means further comprises a comparison means.

13. A method for comparing travel industry information comprising the steps of:
inputting data from at least two data feeds;
aggregating said data;
searching said data; and
presenting the results of said search.

14. A method as in claim 13 wherein the step of inputting data from at least two data feeds further comprises inputting data from at least one XML data feed.

15. A method as in claim 14 wherein the step of inputting data from at least two data feeds further comprises inputting data through at least one API.

16. A method as in claim 13 wherein the step of said aggregating said data further comprises aggregating said data in a database means.

17. A method as in claim 16 wherein the step of said aggregating said data further comprises homogenizing said data before populating said database means.

18. A method as in claim 13 wherein the step of said searching said data further comprises using a search interface means and a SQL query means.

19. A method as in claim 18 wherein the step of said searching said data further comprises using an Internet access means for searching said data.

20. A method as in claim 13 wherein the step of presenting the results of said search further comprises outputting any result of said search over an Internet connection.

21. A method as in claim 20 wherein the step of outputting any result of said search over an Internet connection further comprises comparing the result of said search.

22. A method for comparing cruise industry information comprising the steps of:
inputting data from at least one XML data feed and at least one data feed through an API;
homogenizing said data;
populating a database means with said data;
searching said data using a search interface means and a SQL query means; and
presenting the results of said search through outputting any result of said search over an Internet connection.

23. A method as in claim 20 wherein the step of outputting any result of said search over an Internet connection further comprises comparing the result of said search.

24. A database produced by the method of claim 13.

25. A database produced by the method of claim 22.

26. A computerized method for booking travel comprising the steps of:
searching for a cruise;
further selecting certain preferences for a cruise;
further selecting a specific travel class or cabin category for said cruise;
further selecting a specific cabin location for said cruise;
further selecting any other options for said cruise;
providing a summary of all selections for said cruise;
paying for said cruise; and,
confirming said booking on said cruise.

27. A method of evaluating a variety of cruises available during a selected period of time by a customer using a browser running on a client computer, said method comprising the steps of:
sending a first request by the browser to the cruise domain name host for a first HTML document listing and describing the cruises available during the selected time period;
displaying the HTML document on the client's computer,
selecting, by said client, the cruise;
sending a state object from the host server to said browser, wherein the state object identifies the selected cruise; and
storing the state object on the client computer by the browser.

28. The method of claim 27, further comprising the steps of:
selecting cruise information by the client from the list of cruises provided to the client's computer;
requesting comparison of the attributes of the selected cruises and by a single click, sending the request by browser from the client computer to the host server, thereby accessing a Cruise Comparison Tool;
re-formatting the stored cruise data by the Cruise Comparison Tool into a comparative document; and
sending to the comparative document from the host server to the client computer by the browser.

29. The comparative document provided by the Cruise Comparison Tool of claim 28.

30. A Cruise Comparison Tool comprising means for comparing cruise data from at least two sources and means for presenting said data through an Internet connection.
